(19) United States
(12) Patent Application Publication
(10) Pub. No.: US 2026/0285062 A1
(43) Pub. Date: Sep. 24, 2026

(54) LIQUID DISCHARGE APPARATUS, LIQUID DISCHARGE SYSTEM, AND LIQUID DISCHARGE METHOD

(71) Applicants: Hajime ONUKI, Kanagawa (JP); Teppei KIKUCHI, Kanagawa (JP); Aki TAKAHASHI, Kanagawa (JP); Er Sin KHOO, Kanagawa (JP); Yuta KOBAYASHI, Tokyo (JP)

(72) Inventors: Hajime ONUKI, Kanagawa (JP); Teppei KIKUCHI, Kanagawa (JP); Aki TAKAHASHI, Kanagawa (JP); Er Sin KHOO, Kanagawa (JP); Yuta KOBAYASHI, Tokyo (JP)

(73) Assignee: Ricoh Company, Ltd., Ohta-ku, Tokyo (JP)

(21) Appl. No.: 19/556,271

(22) Filed: Mar. 4, 2026

(30) Foreign Application Priority Data
Mar. 18, 2025 (JP) 2025-043268
Dec. 24, 2025 (JP) 2025-281239

(51) Int. Cl. B41J 11/00; B41J 3/60

(52) U.S. Cl. CPC B41J 11/00222; B41J 3/60; B41J 11/0005

(57) ABSTRACT

A liquid discharge apparatus includes: a conveyor configured to convey a medium in a conveyance direction; a liquid discharger configured to discharge a liquid onto the medium conveyed by the conveyor; a first superheated-steam discharger disposed downstream of the liquid discharger in the conveyance direction, the first superheated-steam discharger configured to discharge first superheated steam onto the medium on which the liquid has been discharged; and a second superheated-steam discharger disposed downstream of the first superheated-steam discharger in the conveyance direction, the second superheated-steam discharger configured to discharge second superheated steam onto the medium on which the first superheated steam has been discharged.

### CROSS-REFERENCE TO RELATED APPLICATIONS

This patent application is based on and claims priority pursuant to 35 U.S.C. § 119(a) to Japanese Patent Application No. 2025-043268, filed on Mar. 18, 2025, in the Japan Patent Office, and Japanese Patent Application No. 2025-281239, filed on Dec. 24, 2025, in the Japan Patent Office, the entire disclosure of which is hereby incorporated by reference herein.

### BACKGROUND

### Technical Field

The present embodiment relates to a liquid discharge apparatus, a liquid discharge system, and a liquid discharge method.

### Related Art

In an inkjet type image forming apparatus, there is a technique of heating and drying liquids of ink discharged onto a recording medium such as a paper surface with superheated steam.

### SUMMARY

The present disclosure provides a liquid discharge apparatus including: a conveyor configured to convey a medium in a conveyance direction; a liquid discharger configured to discharge a liquid onto the medium conveyed by the conveyor; a first superheated-steam discharger disposed downstream of the liquid discharger in the conveyance direction, the first superheated-steam discharger configured to discharge first superheated steam onto the medium on which the liquid has been discharged; and a second superheated-steam discharger disposed downstream of the first superheated-steam discharger in the conveyance direction, the second superheated-steam discharger configured to discharge second superheated steam onto the medium on which the first superheated steam has been discharged.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is an overall diagram illustrating a configuration example of an image forming system according to a first embodiment;

FIG. 2 is a diagram illustrating an example of a main part of the image forming system according to the first embodiment;

FIG. 3 is a diagram illustrating an example of a hardware configuration of a main part of a control function of the image forming system according to the first embodiment;

FIG. 4 is a diagram illustrating an example of a functional configuration of a control unit of the image forming system according to the first embodiment;

FIG. 5 is a flowchart illustrating an example of an image forming method according to the first embodiment;

FIG. 6 is an overall diagram illustrating a configuration example of an image forming system according to a second embodiment;

FIG. 7 is a diagram illustrating an example of a main part of the image forming system according to the second embodiment;

FIG. 8 is a diagram illustrating an example of a functional configuration of a control unit of the image forming system according to the second embodiment;

FIG. 9 is a flowchart illustrating an example of an image forming method according to the second embodiment; and

FIG. 10 is a diagram illustrating an example of a main part of an image forming system according to a third embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### First Embodiment

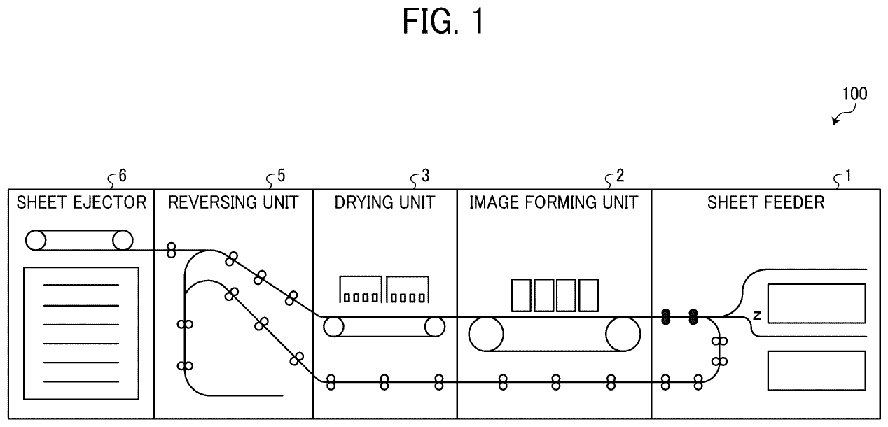

FIG. 1 is an overall diagram illustrating a configuration example of an image forming system 100 according to a first embodiment. The image forming system 100 (an example of a system configuration of a liquid discharge apparatus) includes a sheet feeder 1, an image forming unit 2, a drying unit 3, a reversing unit 5, and a sheet ejector 6.

The sheet feeder 1 conveys the stacked recording media (for example, paper) one by one toward the image forming unit 2.

The image forming unit 2 forms an image on a recording medium by an inkjet method. Specifically, the image forming unit 2 forms an image by discharging ink toward the recording medium conveyed from the sheet feeder 1 or the reversing unit 5 and applying the ink to the recording medium. The image forming unit 2 conveys the recording medium on which the image is formed to the drying unit 3.

The drying unit 3 brings superheated steam, which is water vapor having an ejection temperature higher than 100° C., into contact with the recording medium conveyed from the image forming unit 2 to dry the recording medium onto which ink droplets have been discharged. The drying unit 3 conveys the dried recording medium to the reversing unit 5.

The reversing unit 5 reverses a first surface (printing surface) and a second surface of the recording medium conveyed from the drying unit 3 and conveys the recording medium to the image forming unit 2. The reversing unit 5 conveys the recording medium conveyed from the drying unit 3 to the sheet ejector 6. The reversing unit 5 reverses the first surface and the second surface of the recording medium and conveys the recording medium to the image forming unit 2 only at the time of duplex printing.

The sheet ejector 6 stacks the recording medium conveyed from the reversing unit 5.

For example, each of the sheet feeder 1, the image forming unit 2, the drying unit 3, the reversing unit 5, and the sheet ejector 6 described above may be implemented as an independent device. For example, among the sheet feeder 1, the image forming unit 2, the drying unit 3, the reversing unit 5, and the sheet ejector 6 described above, a combination of devices including a plurality of functional units or a single device including all functional units may be used.

For example, the sheet feeder 1 and the image forming unit 2 as liquid discharge apparatuses, and the drying unit 3, the reversing unit 5, and the sheet ejector 6 as drying apparatuses may constitute an independently configured liquid discharge system. For example, a conveyor 7 that conveys a recording medium 101, a liquid discharge apparatus that discharges a liquid to the recording medium 101, a superheated-steam discharger 31a that brings superheated steam into contact with the recording medium 101 onto which the liquid has been discharged, and a superheated-steam discharger 31b that brings superheated steam into contact with recording medium 101 on a downstream side of the superheated-steam discharger 31a in a conveyance direction of the recording medium 101 may constitute an independently configured liquid discharge system. The recording medium 101 may be referred to simply as a “medium”.

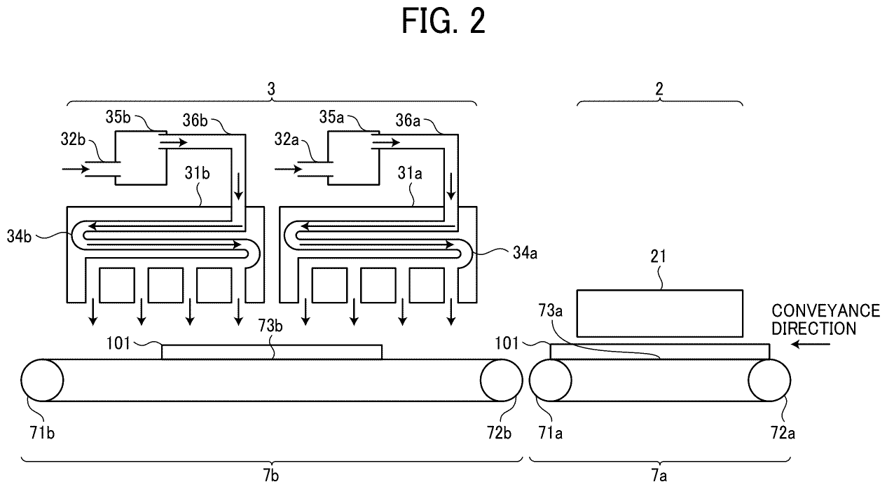

FIG. 2 is a diagram illustrating an example of a main part of the image forming system 100 according to the first embodiment. FIG. 2 illustrates the image forming unit 2 and the drying unit 3 in the overall configuration illustrated in FIG. 1.

The image forming unit 2 includes a recording head 21. The recording medium 101 is moved in the conveyance direction by a conveyor 7a, and an image is formed by ink (for example, aqueous ink) discharged from the recording head 21. The recording head 21 may be referred to as “a liquid discharge head”.

The conveyors 7a and 7b include driving rollers 71a and 71b driven by a motor and driven rollers 72a and 72b that are rotationally driven. The conveyors 7a and 7b include conveying belts 73a and 73b driven by the driving rollers 71a and 71b and the driven rollers 72a and 72b.

The image forming system 100 includes the drying unit 3 on the downstream side of the image forming unit 2 in the conveyance direction. The drying unit 3 includes the superheated-steam dischargers 31a and 31b. The superheated-steam discharger 31a is located upstream of the superheated-steam discharger 31b in the conveyance direction. The drying unit 3 includes the conveyor 7b. The recording medium 101 receives the superheated steam ejected by the superheated-steam dischargers 31a and 31b while being moved in the conveyance direction by the conveyor 7b. As a result, the ink on the recording medium 101 is dried.

The superheated-steam dischargers 31a and 31b include water supply units 32a and 32b and steam generation mechanisms 35a and 35b, and the amount of water supplied is controlled by a water supply mechanism to the water supply unit 32a.

The water supplied from the water supply units 32a and 32b is heated by the steam generation mechanisms 35a and 35b, sent as water vapor to heating passages 34a and 34b via air supply paths 36a and 36b, heated in the superheated-steam dischargers 31a and 31b, and ejected to the recording medium 101 as superheated steam (water vapor at 100° C. or higher). Specifically, the water is heated through the heating passages 34a and 34b, and is sprayed to the ink on the recording medium 101 as superheated steam.

The temperature of the superheated steam is controlled by the heating passages 34a and 34b, and the amount of the water vapor is controlled by the supply ratio of water.

An air supply unit can be provided in the heating passage 34a, and the amount of water vapor is controlled by controlling the amount of intake air. The air supply unit is located on the downstream side of the heating passage 34a with respect to the air supply path 36a, and the air is supplied in a state where the water vapor supplied in the air supply path 36a is heated to a prescribed temperature (a temperature at which the steam does not condense even when mixed with air at normal temperature).

Similarly, an air supply unit can be provided in the heating passage 34b, the air supply unit is located on the downstream side of the air supply path 36b with respect to the water supply unit 32b, and the air is supplied in a state where the water vapor supplied through the air supply path 36a is heated to a specified temperature (temperature at which the steam does not condense even when mixed with the air at normal temperature).

The superheated-steam dischargers 31a and 31b can control the temperature and amount of superheated steam to be ejected, respectively. That is, the image forming system 100 according to the first embodiment has a mechanism in which the temperature and the humidity of the superheated steam can be separately controlled in the upstream portion and the downstream portion in the conveyance direction of the recording medium 101.

The temperature of the superheated steam ejected from the superheated-steam discharger 31a in the upstream portion in the conveyance direction is higher than the temperature of the superheated steam ejected from the superheated-steam discharger 31b. The amount of superheated steam ejected from the superheated-steam discharger 31a in the upstream portion in the conveyance direction is smaller than the amount of superheated steam ejected from the superheated-steam discharger 31b. That is, the superheated-steam discharger 31a in the upstream portion has a function of lowering the saturation water vapor amount in the vicinity of the ink surface and rapidly heating the ink to evaporate moisture in the ink by increasing the temperature of the superheated steam and lowering the water vapor amount. As a result, the solvent in the ink can be evaporated at a high speed, and the film formation of the ink can be promoted.

The temperature of the superheated steam ejected from the superheated-steam discharger 31b in the downstream portion in the conveyance direction is lower than the temperature of the superheated steam ejected from the superheated-steam discharger 31a. The amount of superheated steam ejected from the superheated-steam discharger 31b in the downstream portion in the conveyance direction is larger than the amount of superheated steam ejected from the superheated-steam discharger 31a. That is, the superheated-steam discharger 31b in the downstream portion has a function of increasing the saturated vapor amount in the vicinity of the surface of the recording medium 101 onto which the ink has been applied by lowering the temperature of the superheated steam and increasing the water vapor amount so as to suppress the evaporation of the moisture in the recording medium 101 and adjust the water content while promoting the evaporation of the solvent in the ink. As a result, the saturated vapor amount in the vicinity of the ink/paper surface can be increased to adjust the water content of the recording medium 101.

In order to promote the drying property of the ink, the superheated-steam discharger 31b may bring an amount of superheated steam smaller than the amount of superheated steam ejected from the superheated-steam discharger 31a into contact with the recording medium onto which the liquid has been discharged.

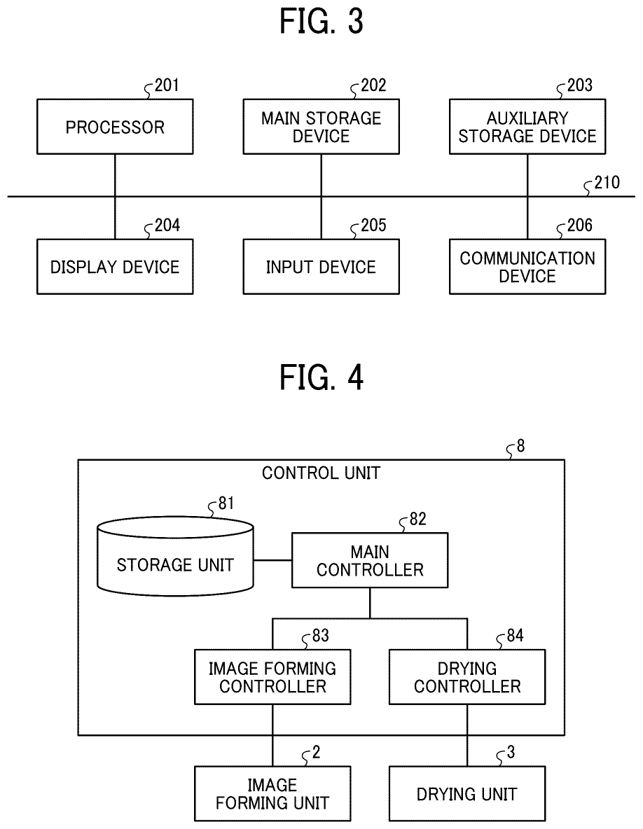

FIG. 3 is a diagram illustrating an example of a hardware configuration of a main part of a control function of the image forming system 100 according to the first embodiment. The image forming system 100 includes a processor 201, a main storage device 202, an auxiliary storage device 203, a display device 204, an input device 205, and a communication device 206. The processor 201, the main storage device 202, the auxiliary storage device 203, the display device 204, the input device 205, and the communication device 206 are connected via a bus 210.

The image forming system 100 does not necessarily include a part of the above configuration. For example, in a case where the image forming system 100 can use an input function and a display function of an external device, the image forming system 100 does not necessarily include the display device 204 and the input device 205.

The processor 201 executes a program read from the auxiliary storage device 203 to the main storage device 202. The main storage device 202 is a memory such as a read only memory (ROM) and a random access memory (RAM). The auxiliary storage device 203 is a hard disk drive (HDD), a memory card, or the like.

The display device 204 is, for example, a liquid crystal display or the like. The input device 205 is an interface for operating the image forming system 100. The display device 204 and the input device 205 may be implemented by a touch panel or the like having a display function and an input function. The communication device 206 is an interface for communicating with other devices.

For example, the program executed by the image forming system 100 is a file in an installable format or an executable format, is recorded in a computer-readable storage medium such as a memory card, a hard disk, a compact disc rewritable (CD-RW), a CD-ROM, a compact disc recordable (CD-R), a digital versatile disc (DVD)-RAM, and a DVD-R, and is provided as a computer program product.

The program to be executed in the image forming system 100 may be stored on a computer connected to a network, such as the Internet, and may be downloaded through the network for provision.

For example, the program executed by the image forming system 100 may be provided via a network such as the Internet without being downloaded. For example, the program of the image forming system 100 may be provided by being incorporated in advance in a ROM or the like.

The program executed by the image forming system 100 has a module configuration including functions that can also be implemented by the program. As actual hardware, the processor 201 reads a program from a storage medium and executes the program, whereby the functional blocks are loaded on the main storage device 202. That is, the functional blocks are generated on the main storage device 202.

Some or all of the above-described functions may not be implemented by software but may be implemented by hardware such as an integrated circuit (IC).

Each function may be implemented using a plurality of processors 201, and in this case, each processor 201 may implement one of the functions or may implement two or more of the functions.

FIG. 4 is a diagram illustrating an example of a functional configuration of a control unit 8 of the image forming system 100 according to the first embodiment. The control unit 8 controls the operation of the image forming system 100. The control unit 8 includes a storage unit 81, a main controller 82, an image forming controller 83, a drying controller 84, and a flattening controller 85.

Each function of the control unit 8 may be implemented using a plurality of processors 201, and in this case, each processor 201 may implement one of the functions or may implement two or more of the functions.

The storage unit 81 holds data such as an image to be printed. The storage unit 81 is implemented by the main storage device 202 and the auxiliary storage device 203 described above.

The main controller 82, the image forming controller 83, and the drying controller 84 are implemented by the processor 201 described above.

The main controller 82 issues an instruction to write data to the storage unit 81 and an instruction to read data from the storage unit 81. The main controller 82 issues control instructions to the image forming controller 83 and the drying controller 84.

The image forming controller 83 controls the operation of the image forming unit 2 in accordance with a control instruction from the main controller 82. For example, the image forming controller 83 controls the start of the operation of the image forming unit 2.

The drying controller 84 controls the operation of the drying unit 3 in accordance with a control instruction from the main controller 82. For example, the drying controller 84 independently controls the temperature of the first superheated steam discharged from the superheated-steam discharger 31a (an example of the first superheated-steam discharger) and the temperature of the second superheated steam discharged from the superheated-steam discharger 31b (an example of the second superheated-steam discharger). For example, the drying controller 84 independently controls the amount of the first superheated steam discharged from the superheated-steam discharger 31a and the amount of the second superheated steam discharged from the superheated-steam discharger 31b.

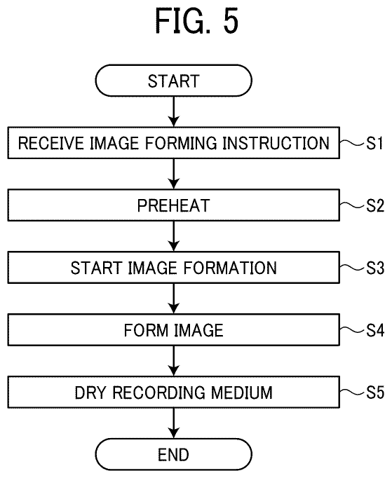

FIG. 5 is a flowchart illustrating an example of an image forming method according to the first embodiment. First, when an image forming instruction is received in response to a user's operation input or the like (step S1), the main controller 82 inputs a preheating instruction to the drying controller 84.

Next, when the residual heat instruction is received from the main controller 82, the drying controller 84 causes the drying unit 3 to be heated (step S2). The drying unit 3 is heated at a prescribed superheated steam temperature until a prescribed amount of superheated steam is available.

The preheating condition of the drying unit 3 varies depending on the type of the recording medium 101.

Next, when the drying unit 3 is heated to the preheating condition, the main controller 82 starts the image forming processing (step S3). When starting the image forming processing, the main controller 82 inputs an image forming start instruction to the image forming controller 83.

Next, when an image forming start instruction is received from the main controller 82, the image forming controller 83 forms an image on the recording medium 101 (step S4). Thereafter, the recording medium 101 is sent to the preheated drying unit 3, and image formation is completed (steps S5 and S6).

In a case where all the image forming processes are completed, the main controller 82 inputs a preheating stop instruction to the drying controller 84 and the flattening controller 85 to stop heating of the drying unit 3.

As described above, in the image forming system 100 (an example of a system configuration of the liquid discharge apparatus) according to the first embodiment, the conveyors 7a and 7b convey the recording medium 101.

The recording head 21 discharges a liquid onto the recording medium 101. The superheated-steam discharger 31a (an example of the first superheated-steam discharger) brings the first superheated steam into contact with the recording medium 101 onto which the liquid has been discharged. Then, the superheated-steam discharger 31b (an example of the second superheated-steam discharger) brings the second superheated steam into contact with the recording medium 101 on the downstream side of the superheated-steam discharger 31a in the conveyance direction of the recording medium 101. The recording head 21 is an example of a liquid discharger.

As a result, according to the image forming system 100 according to the first embodiment, it is possible to suppress a decrease in the water content of the recording medium and to dry the recording medium onto which the liquid has been discharged.

Specifically, in the image forming system 100 according to the first embodiment, the discharge temperature of the superheated steam on the downstream side in the conveyance direction of the recording medium 101 is higher than the discharge temperature of the superheated steam on the upstream side. That is, the effect of evaporating the solvent in the ink by the upstream superheated steam and forming the ink film is exhibited, and the effect of humidifying the recording medium on the downstream side is exhibited.

In short, the image forming system 100 according to the first embodiment can adjust the water content of the recording medium 101 by the downstream superheated steam. Specifically, with respect to the superheated steam after printing, the superheated steam on the downstream side is brought to a low temperature and brought into contact with the recording medium 101, whereby the water content of the recording medium 101 after drying can be adjusted.

### Second Embodiment

Next, a second embodiment will be described. In the following description of the second embodiment, descriptions of elements identical or similar to those in the first embodiment are omitted, and differences from the first embodiment are described.

In a case where the recording medium 101 is thin paper, the paper may be thermally deformed by the processing in the drying unit 3. Therefore, in the second embodiment, an embodiment in a case where the flattener 4 is provided downstream of the drying unit 3 and the flattener 4 for correcting the recording medium 101 deformed by the drying unit 3 is provided will be described.

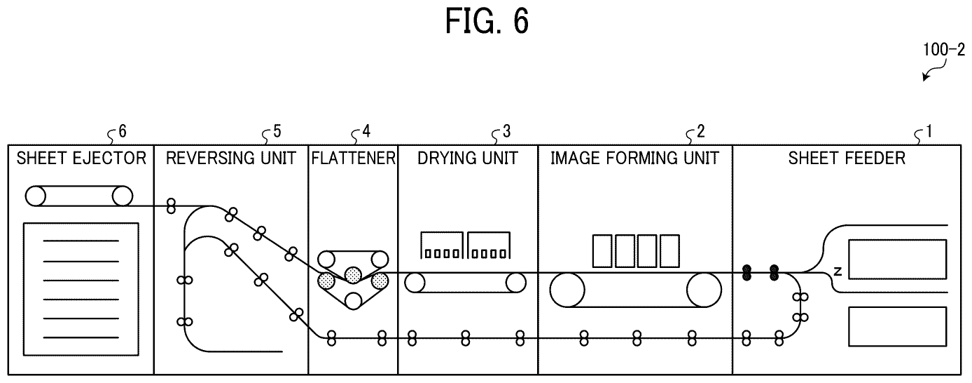

FIG. 6 is an overall diagram illustrating a configuration example of an image forming system 100-2 according to a second embodiment. The image forming system 100-2 includes a sheet feeder 1, an image forming unit 2, a drying unit 3, a flattener 4, a reversing unit 5, and a sheet ejector 6.

The sheet feeder 1 conveys the stacked recording media (for example, paper) one by one toward the image forming unit 2.

The image forming unit 2 forms an image on a recording medium by an inkjet method. Specifically, the image forming unit 2 forms an image by discharging ink toward the recording medium conveyed from the sheet feeder 1 or the reversing unit 5 and applying the ink to the recording medium. The image forming unit 2 conveys the recording medium on which the image is formed to the drying unit 3.

The drying unit 3 brings superheated steam into contact with the recording medium conveyed from the image forming unit 2 to dry the recording medium onto which ink droplets have been discharged. The drying unit 3 conveys the dried recording medium to the flattener 4.

The flattener 4 corrects deformation of the recording medium conveyed from the drying unit 3 (for example, heating while winding the recording medium around a heat roller). Then, the flattener 4 conveys the corrected recording medium to the reversing unit 5.

The reversing unit 5 reverses a first surface (printing surface) and a second surface of the recording medium conveyed from the flattener 4 and conveys the recording medium to the image forming unit 2. The reversing unit 5 conveys the recording medium conveyed from the flattener 4 to the sheet ejector 6. The reversing unit 5 reverses the first surface and the second surface of the recording medium and conveys the recording medium to the image forming unit 2 only at the time of duplex printing.

The sheet ejector 6 stacks the recording medium conveyed from the reversing unit 5.

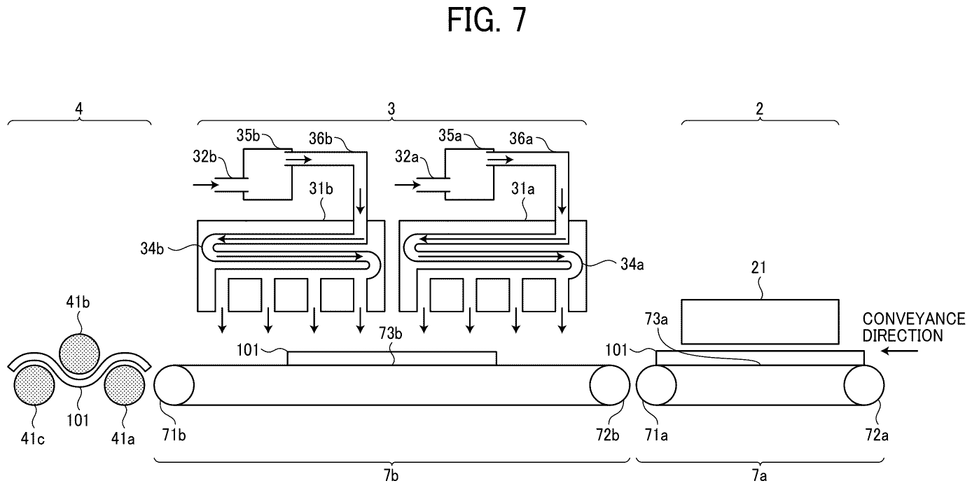

FIG. 7 is a diagram illustrating an example of a main part of the image forming system 100-2 according to the second embodiment. FIG. 7 illustrates the image forming unit 2 and the drying unit 3 in the overall configuration illustrated in FIG. 6. Although FIG. 7 illustrates a case where the flattener 4 is provided, the image forming unit 2 and the drying unit 3 are similar to those in the first embodiment (see FIG. 2), and thus description thereof is omitted.

The image forming system 100-2 includes the flattener 4 on the downstream side of the drying unit 3 in the conveyance direction. In the flattener 4, the plurality of heat rollers 41a to 41c is alternately arranged so as to be in contact with the first surface and the second surface of the recording medium 101. By winding the recording medium 101 around the heat rollers 41a to 41c and heating the recording medium while extending, deformation of the recording medium 101 caused by image formation/drying is smoothly corrected.

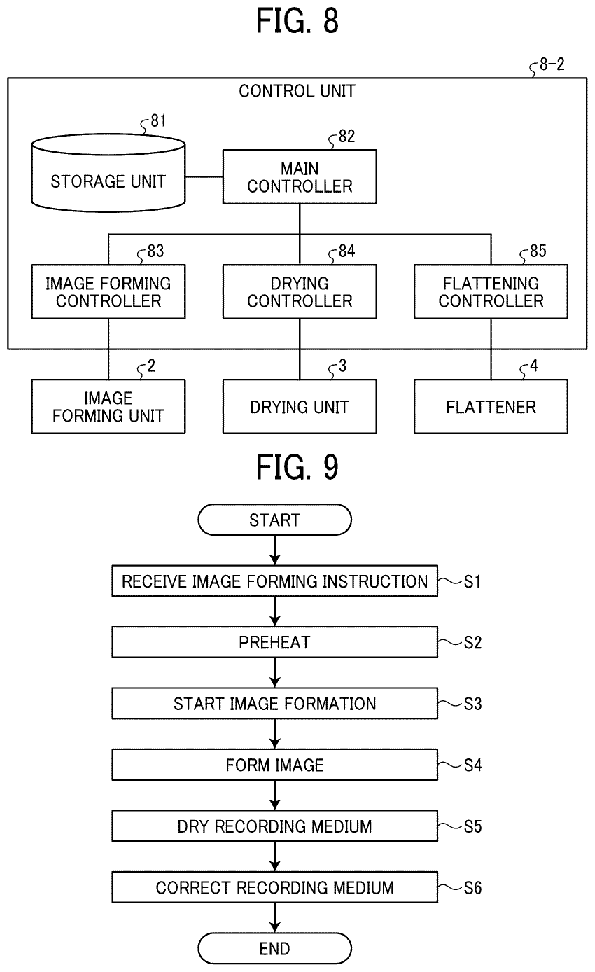

FIG. 8 is a diagram illustrating an example of a functional configuration of a control unit 8-2 of the image forming system 100-2 according to the second embodiment. The control unit 8-2 includes a storage unit 81, a main controller 82, an image forming controller 83, and a drying controller 84. In the control unit 8-2, since the image forming system 100-2 includes the flattener 4, the flattening controller 85 is provided. Since the storage unit 81, the main controller 82, the image forming controller 83, and the drying controller 84 are similar to those in the first embodiment, the description thereof will be omitted.

The flattening controller 85 controls the operation of the flattener 4 in accordance with a control instruction from the main controller 82. For example, the flattening controller 85 controls the start of the operation of the flattener 4.

FIG. 9 is a flowchart illustrating an example of an image forming method according to the second embodiment. Since the image forming system 100-2 includes the flattener 4, the processing of step S6 is performed after step S5 in the example of FIG. 9. Since the processing of steps S1 to S5 is similar to that of the flowchart of the first embodiment (see FIG. 5), description of the processing other than the control related to the flattener 4 is omitted.

First, when an image forming instruction is received in response to a user's operation input or the like (step S1), the main controller 82 also inputs a preheating instruction to the flattening controller 85.

Next, when the residual heat instruction is received from the main controller 82, the flattening controller 85 causes the flattener 4 to be heated (step S2). The flattener 4 is heated to a prescribed heat roller temperature.

The preheating condition of the flattener 4 varies depending on the type of the recording medium 101.

Next, when the drying unit 3 and the flattener 4 are heated to the preheating condition, the main controller 82 starts the image forming processing (step S3). When starting the image forming processing, the main controller 82 inputs an image forming start instruction to the image forming controller 83.

Next, when an image forming start instruction is received from the main controller 82, the image forming controller 83 forms an image on the recording medium 101 (step S4). Thereafter, the recording medium 101 is sent to the preheated drying unit 3 and the preheated flattener 4, and image formation is completed (steps S5 and S6).

In a case where all the image forming processes are completed, the main controller 82 also inputs a preheating stop instruction to the flattening controller 85 to stop heating of the flattener 4.

According to the image forming system 100-2 according to the second embodiment, effects similar to those of the first embodiment can be obtained. That is, by dividing the temperature and the spray amount of the superheated steam of the drying unit 3 into the upstream side and the downstream side, and increasing the temperature of the superheated steam on the upstream side and decreasing the spray amount, the ink can be increased in temperature at a high speed, and the evaporation and film formation of the ink can be promoted by not excessively increasing the humidity of the atmosphere by the small amount of superheated steam. By lowering the temperature of the superheated steam on the downstream side and increasing the ejection amount, moisture of the superheated steam can be absorbed by the recording medium 101 to adjust the water content.

### Third Embodiment

Next, a third embodiment will be described. In the description of the third embodiment, since components other than the main components of the image forming unit and the drying unit in the first embodiment have similar configurations, the main components of the image forming unit and the drying unit different from those in the first embodiment will be described.

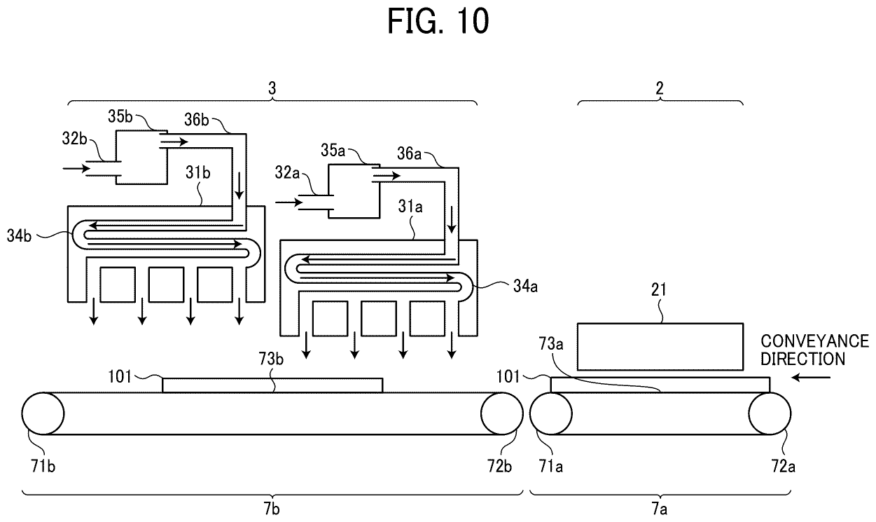

FIG. 10 is a diagram illustrating an example of the image forming unit 2 and the drying unit 3 according to a third embodiment.

Regarding the configurations of the image forming unit 2 and the drying unit 3 in FIG. 10, the description of the same portions as those of the first embodiment (see FIG. 2) will be omitted.

In the third embodiment, the distance between the superheated-steam discharger 31a and the recording medium 101 is smaller than the distance between the superheated-steam discharger 31b and the recording medium 101. As a result, the amount of heat of the superheated steam ejected from the superheated-steam discharger 31a is easily transmitted to the recording medium, and the evaporation efficiency of the ink in the superheated-steam discharger 31a (an example of the first superheated-steam discharger) is improved.

A liquid discharge apparatus includes: a conveyor (7) configured to convey a medium in a conveyance direction; a liquid discharger (21) configured to discharge a liquid onto the medium conveyed by the conveyor; a first superheated-steam discharger (31a) disposed downstream of the liquid discharger (21) in the conveyance direction, the first superheated-steam discharger (31a) configured to discharge first superheated steam onto the medium on which the liquid has been discharged; and a second superheated-steam discharger (31b) disposed downstream of the first superheated-steam discharger (31a) in the conveyance direction, the second superheated-steam discharger (31b) configured to discharge second superheated steam onto the medium on which the first superheated steam has been discharged.

The first superheated-steam discharger (31a) has a first gap between the first superheated-steam discharger (31a) and the medium; and the second superheated-steam discharger (31b) has a second gap, larger than the first gap, between the second superheated-steam discharger (31b) and the medium.

The first superheated-steam discharger (31a) discharges the first superheated steam having a first temperature; and the second superheated-steam discharger (31b) discharges the second superheated steam having a second temperature lower than the first temperature.

The first superheated-steam discharger (31a) discharges a first amount of the first superheated steam; and the second superheated-steam discharger (31b) discharges a second amount, larger than the first amount, of the second superheated steam.

The first superheated-steam discharger (31a) discharges a first amount of the first superheated steam; and the second superheated-steam discharger (31b) discharges a second amount, smaller than the first amount, of the second superheated steam.

The liquid discharge apparatus further includes: a flattener (4) disposed downstream of the second superheated-steam discharger (31b) in the conveyance direction, and the flattener (4) configured to correct deformation of the medium.

The flattener (4) includes a heat roller to: heat the medium; and stretches the medium.

The liquid discharge apparatus further includes: a processor (201) configured to independently control: the first temperature of the first superheated steam; and the second temperature of the second superheated.

The liquid discharge apparatus further includes: a processor (201) configured to independently control: the first amount of the first superheated steam; and the second amount of the second superheated.

A liquid discharge system includes: a conveyor (7) configured to convey a medium in a conveyance direction; a liquid discharger (21) configured to discharge a liquid onto the medium conveyed by the conveyor; a first superheated-steam discharger (31a) disposed downstream of the liquid discharger (21) in the conveyance direction, the first superheated-steam discharger (31a) configured to discharge first superheated steam onto the medium on which the liquid has been discharged; and a second superheated-steam discharger (31b) disposed downstream of the first superheated-steam discharger (31a) in the conveyance direction, the second superheated-steam discharger (31b) configured to discharge second superheated steam onto the medium on which the first superheated steam has been discharged.

A liquid discharge method includes: conveying a medium in a conveyance direction; discharging a liquid onto the medium conveyed; discharging a first superheated steam onto the medium on which the liquid has been discharged; and discharging a second superheated steam onto the medium on which the first superheated steam has been discharged.

Aspects of the present embodiment are, for example, as follows.

### Aspect 1

According to Aspect 1, a liquid discharge apparatus includes:
a conveyor configured to convey a recording medium;
a liquid discharger configured to discharge a liquid onto the recording medium;
a first superheated-steam discharger configured to bring first superheated steam into contact with the recording medium onto which the liquid has been discharged; and
a second superheated-steam discharger configured to bring second superheated steam into contact with the recording medium on a downstream side of the first superheated-steam discharger in a conveyance direction of the recording medium.

### Aspect 2

According to Aspect 2, in the liquid discharge apparatus of Aspect 1,
a distance between the first superheated-steam discharger and the recording medium is smaller than a distance between the second superheated-steam discharger and the recording medium.

### Aspect 3

According to Aspect 3, in the liquid discharge apparatus of Aspect 1,
the first superheated-steam discharger brings superheated steam having a temperature higher than a temperature of the second superheated steam into contact with the recording medium onto which the liquid has been discharged.

### Aspect 4

According to Aspect 4, in the liquid discharge apparatus of Aspect 1,
the second superheated-steam discharger brings second superheated steam in an amount larger than an amount of the first superheated steam into contact with the recording medium onto which the liquid has been discharged.

### Aspect 5

According to Aspect 5, in the liquid discharge apparatus of Aspect 1,
the second superheated-steam discharger brings second superheated steam in an amount smaller than an amount of the first superheated steam into contact with the recording medium onto which the liquid has been discharged.

### Aspect 6

According to Aspect 6, the liquid discharge apparatus of Aspect 1 further includes
a flattener configured to correct deformation of the recording medium on a downstream side of the second superheated-steam discharger in the conveyance direction of the recording medium.

### Aspect 7

According to Aspect 7, in the liquid discharge apparatus of Aspect 6,
the flattener includes a heat roller that heats the recording medium and stretches the recording medium.

### Aspect 8

According to Aspect 8, the liquid discharge apparatus of Aspect 3 further includes
a control unit configured to independently control a temperature of the first superheated steam discharged from the first superheated-steam discharger and a temperature of the second superheated steam discharged from the second superheated-steam discharger.

### Aspect 9

According to Aspect 9, the liquid discharge apparatus of Aspect 4 or 5 further includes
a control unit configured to independently control an amount of the first superheated steam discharged from the first superheated-steam discharger and an amount of the second superheated steam discharged from the second superheated-steam discharger.

### Aspect 10

According to Aspect 10, a liquid discharge system includes:
a conveyor configured to convey a recording medium;
a liquid discharge apparatus configured to discharge a liquid onto the recording medium;
a first superheated-steam discharger configured to bring first superheated steam into contact with the recording medium onto which the liquid has been discharged; and
a second superheated-steam discharger configured to bring second superheated steam into contact with the recording medium on a downstream side of the first superheated-steam discharger in a conveyance direction of the recording medium.

### Aspect 11

According to Aspect 11, a liquid discharge method includes:
a step of conveying a recording medium by a conveyor;
a step of discharging a liquid onto the recording medium by a liquid discharger;
a step of bringing first superheated steam into contact with the recording medium onto which the liquid has been discharged, by a first superheated-steam discharger; and
a step of bringing second superheated steam into contact with the recording medium on a downstream side of the first superheated-steam discharger in a conveyance direction of the recording medium, by a second superheated-steam discharger.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A liquid discharge apparatus comprising:
a conveyor configured to convey a medium in a conveyance direction;
a liquid discharger configured to discharge a liquid onto the medium conveyed by the conveyor;
a first superheated-steam discharger disposed downstream of the liquid discharger in the conveyance direction,
the first superheated-steam discharger configured to discharge first superheated steam onto the medium on which the liquid has been discharged; and
a second superheated-steam discharger disposed downstream of the first superheated-steam discharger in the conveyance direction,
the second superheated-steam discharger configured to discharge second superheated steam onto the medium on which the first superheated steam has been discharged.

2. The liquid discharge apparatus according to claim 1,
wherein the first superheated-steam discharger has a first gap between the first superheated-steam discharger and the medium; and
the second superheated-steam discharger has a second gap, larger than the first gap, between the second superheated-steam discharger and the medium.

3. The liquid discharge apparatus according to claim 1,
wherein the first superheated-steam discharger discharges the first superheated steam having a first temperature; and
the second superheated-steam discharger discharges the second superheated steam having a second temperature lower than the first temperature.

4. The liquid discharge apparatus according to claim 1,
wherein the first superheated-steam discharger discharges a first amount of the first superheated steam; and
the second superheated-steam discharger discharges a second amount, larger than the first amount, of the second superheated steam.

5. The liquid discharge apparatus according to claim 1,
wherein the first superheated-steam discharger discharges a first amount of the first superheated steam; and
the second superheated-steam discharger discharges a second amount, smaller than the first amount, of the second superheated steam.

6. The liquid discharge apparatus according to claim 1, further comprising:
a flattener disposed downstream of the second superheated-steam discharger in the conveyance direction, and
the flattener configured to correct deformation of the medium.

7. The liquid discharge apparatus according to claim 6,
wherein the flattener includes a heat roller to:
heat the medium; and
stretches the medium.

8. The liquid discharge apparatus according to claim 3, further comprising:
a processor configured to independently control:
the first temperature of the first superheated steam; and
the second temperature of the second superheated.

9. The liquid discharge apparatus according to claim 4, further comprising:
a processor configured to independently control:
the first amount of the first superheated steam; and
the second amount of the second superheated.

10. A liquid discharge system comprising:
a conveyor configured to convey a medium in a conveyance direction;
a liquid discharger configured to discharge a liquid onto the medium conveyed by the conveyor;
a first superheated-steam discharger disposed downstream of the liquid discharger in the conveyance direction,
the first superheated-steam discharger configured to discharge first superheated steam onto the medium on which the liquid has been discharged; and
a second superheated-steam discharger disposed downstream of the first superheated-steam discharger in the conveyance direction,
the second superheated-steam discharger configured to discharge second superheated steam onto the medium on which the first superheated steam has been discharged.

11. A liquid discharge method comprising:
conveying a medium in a conveyance direction;
discharging a liquid onto the medium conveyed;
discharging a first superheated-steam onto the medium on which the liquid has been discharged; and
discharging a second superheated-steam onto the medium on which the first superheated-steam has been discharged.
